(19) United States
(12) Patent Application Publication
(10) Pub. No.: US 2011/0154267 A1
(43) Pub. Date: Jun. 23, 2011

(54) Method and Apparatus for Determining an Operation Associsated with a Continuous Stroke Input

(75) Inventor: Mikko Antero Nurmi, Tampere (FI)

(73) Assignee: NOKIA CORPORATION, Espoo (FI)

(21) Appl. No.: 12/646,403

(22) Filed: Dec. 23, 2009

(51) Int. Cl. G06F 3/033; G06F 3/041

(52) U.S. Cl. 715/863; 345/173

(57) ABSTRACT

An apparatus, comprising a processor and memory including computer program code, the memory and the computer program code configured to, working with the processor, cause the apparatus to perform at least the following: receiving indication of a first input associated with a first touch display, receiving indication of a second input relating to an exiting touch display boundary input associated with the first touch display, receiving indication of a third input relating to an entering touch display boundary input associated with a second touch display, receiving indication of a fourth input associated with the second display, determining that a continuous stroke input comprises the first input, second input, third input, and fourth input, and determining an operation based, at least in part, on the continuous stroke input is disclosed.

### TECHNICAL FIELD

The present application relates generally to touch input.

### BACKGROUND

There has been a recent surge in the use of electronic devices that use touch displays. The devices may utilize more than one touch display.

### SUMMARY

Various aspects of examples of the invention are set out in the claims.

An apparatus, comprising a processor, memory including computer program code, the memory and the computer program code configured to, working with the processor, cause the apparatus to perform at least the following: receiving indication of a first input associated with a first touch display, receiving indication of a second input relating to an exiting touch display boundary input associated with the first touch display, receiving indication of a third input relating to an entering touch display boundary input associated with a second touch display, receiving indication of a fourth input associated with the second display, determining that a continuous stroke input comprises the first input, second input, third input, and fourth input, and determining an operation based, at least in part, on the continuous stroke input is disclosed.

A method, comprising receiving indication of a first input associated with a first touch display, receiving indication of a second input relating to an exiting touch display boundary input associated with the first touch display, receiving indication of a third input relating to an entering touch display boundary input associated with a second touch display, receiving indication of a fourth input associated with the second display, determining by a processor that a continuous stroke input comprises the first input, second input, third input, and fourth input, and determining an operation based, at least in part, on the continuous stroke input is disclosed.

A computer-readable medium encoded with instructions that, when executed by a computer, perform receiving indication of a first input associated with a first touch display, receiving indication of a second input relating to an exiting touch display boundary input associated with the first touch display, receiving indication of a third input relating to an entering touch display boundary input associated with a second touch display, receiving indication of a fourth input associated with the second display, determining that a continuous stroke input comprises the first input, second input, third input, and fourth input, and determining an operation based, at least in part, on the continuous stroke input is disclosed.

### BRIEF DESCRIPTION OF THE DRAWINGS

For a more complete understanding of embodiments of the invention, reference is now made to the following descriptions taken in connection with the accompanying drawings in which:

FIGS. 1A-1B are diagrams illustrating input associated with a plurality of displays according to an example embodiment;

FIGS. 2A-2B are diagrams illustrating continuous stroke input associated with a plurality of displays according to an example embodiment;

FIG. 3 is a flow diagram showing a set of operations for determining information for display;

FIG. 4 is a flow diagram showing a set of operations 400 for determining information for display;

FIG. 5A-5E are diagrams illustrating input associated with a touch display according to an example embodiment; and

FIG. 6 is a block diagram showing an apparatus according to an example embodiment.

### DETAILED DESCRIPTON OF THE DRAWINGS

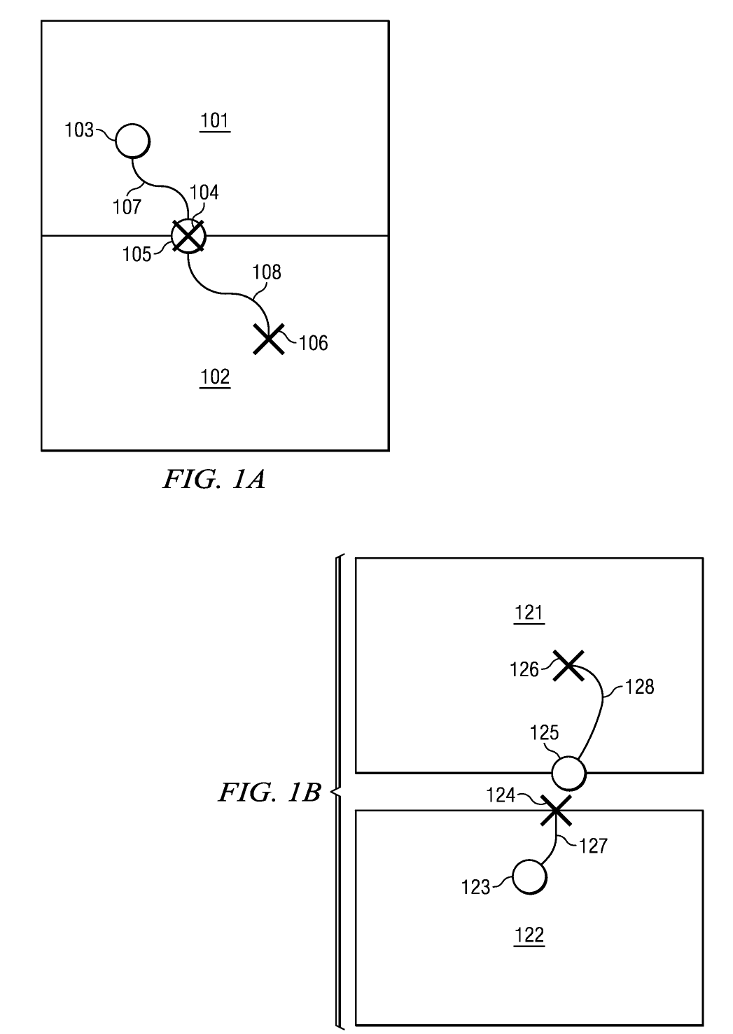

Embodiments of the invention and its potential advantages are understood by referring to FIGS. 1 through 6 of the drawings.

In an example embodiment, an apparatus may allow a user to perform an operation associated with information displayed on a touch display and different information displayed on a different touch display based on the user performing a touch input that spans both displays. For example, an apparatus may be displaying on a first display contact information, such a person's name, address, phone number, email address, and/or the like, and displaying on a second display one or more images. In such an example, the user may select an image on the second display by contacting the display with a finger. The user may then drag his finger to the first display to perform an operation associated with the image and the contact information associated with the person. The operation may relate to sharing the image with the person, sending the image to the person, setting the image as an image for the contact information, attempting to match a person in the image with the person of the contact information, and/or the like.

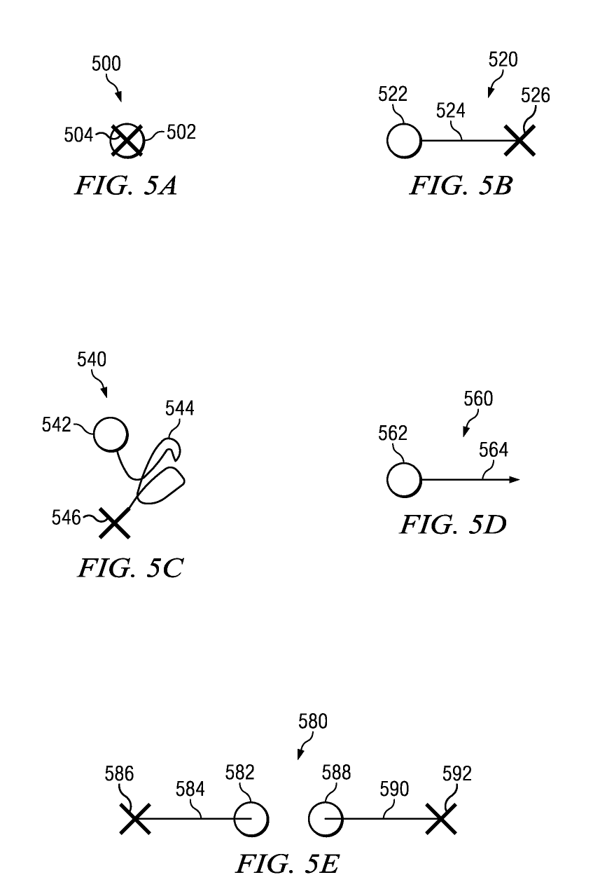

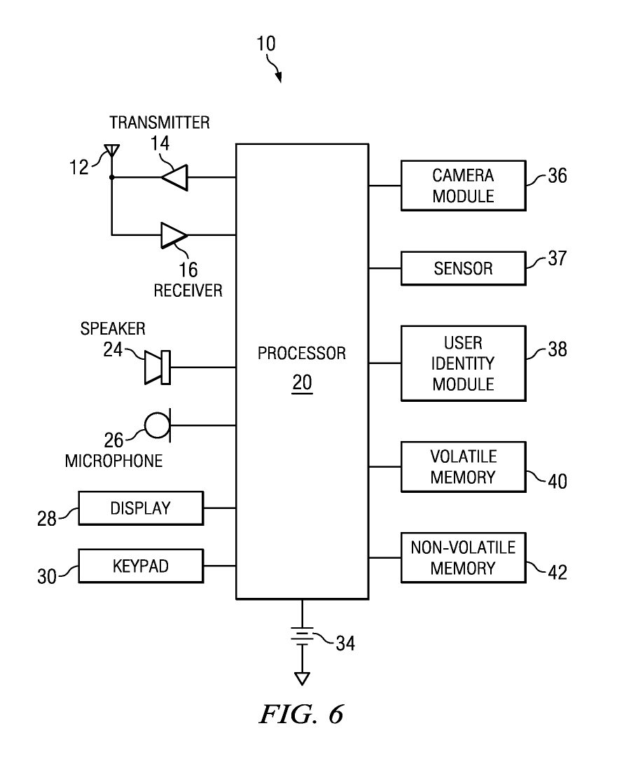

FIGS. 1A-1B are diagrams illustrating input, such as input 544 of FIG. 5C, associated with a plurality of displays, such as display 28 of FIG. 6, according to an example embodiment. The examples of FIGS. 1A-1B are merely examples of possible displays and inputs, and do not limit the scope of the claims. For example, there may be more than two displays. In another example, the displays may be comprised in a common apparatus, in multiple apparatuses, such as monitors, and/or the like. In yet another example, the displays may differ in shape, display technology, touch sensor technology, and/or the like. Although the examples of FIGS. 1A-1B indicate that the displays face the same direction, the angle between displays may vary. For example, the angle between displays may be 180 degrees, 270 degrees, 43 degrees, and/or the like.

The examples of FIGS. 1A-1B illustrate a continuous stroke input associated with a touch display and a different continuous stroke input associated with a different touch display that may be interpreted as a single continuous stroke input associated with both displays. The single continuous stroke inputs associated with two displays of the examples of FIGS. 1A-1B may comprise an input associated with a touch display boundary.

In an example embodiment, a touch display boundary relates to a boundary beyond which touch input is not received by the touch display. For example, a movement input, such as movement input 524 of FIG. 5B, associated with a touch input, such as touch input 520 of FIG. 5B, may relate to a movement where the contact moves beyond or to a touch display boundary. In such an example, the touch input may comprise a release input related to exiting the touch display boundary. Such a release input relating to an exiting touch display boundary input may be positioned near or at a touch display boundary. In another example, a movement input, such as movement input 544 of FIG. 5C, associated with a touch input, such as touch input 540 of FIG. 5C, may relate to a movement where contact with an apparatus comprising a touch display is beyond a touch display boundary and the movement associated with the contact crosses the touch display boundary. In such an example, crossing of the touch display boundary may be associated with a contact input relating to an entering touch display boundary input. Such a contact input relating to an entering touch display boundary input may be positioned near or at a touch display boundary.

In an example embodiment, an apparatus may determine that one or more inputs associated with a first touch display and one or more inputs associated with a second touch display are comprised in a single continuous stroke input based, at least in part, on the inputs from the first display to the inputs of the second display. For example, the determination of a continuous stroke input may be based, at least in part, on receiving an input relating to an exiting touch display boundary input associated with the first touch and receiving an input relating to an entering touch display boundary input associated with the second touch display, within a time limit. In another example, the determination of a continuous stroke input may be based, at least in part, on a position associated with an exiting touch display boundary input associated with the first touch display and a position associated with an entering touch display boundary input. In still another example, the determination of a continuous stroke input may be based, at least in part, on receiving an entering touch input associated with the second display before receiving an exiting touch input associated with the first touch display.

FIG. 1A illustrates a continuous stroke input associated with touch display 101 and touch display 102, according to an example embodiment. In the example of FIG. 1A, the continuous stroke input associated with touch display 101 and touch display 102 comprises contact inputs 103 and 105, movement inputs 107 and 108, and release inputs 104 and 106. Release input 104 relates to an exiting touch display boundary input associated with display 101. Contact input 105 relates to an entering touch display boundary input associated with touch display 102.

In the example of FIG. 1A, an apparatus, such as electronic device 10 of FIG. 6 or a portion thereof, may determine that inputs 103-108 are comprised by a continuous stroke input based, at least in part, on a relationship between release input 104 and contact input 105. For example, the apparatus may determine that release input 104 was received within a time limit from receiving contact input 105. In such an example, the apparatus may receive release input 104 and contact input 105 within 300 milliseconds of each other. In such an example, the time limit may be based, at least in part, on a speed associated with the continuous stroke input, such as by determining a likely amount of time for the implement performing the input to transition between displays if movement speed is maintained. In another example, the apparatus may determine that a position associated with release input 104 is similar to a position associated with contact input 105. In such an example, the similarity may relate to the positions being near each other in accordance to the arrangement of touch display 101 and touch display 102. In still another example, the apparatus may determine that contact input 105 was received before release input 104. In such an example, such a determination may indicate that an implement associated with performing input, such as a finger pad, a finger tip, and/or the like, spans between touch display 101 and touch display 102 while performing input, thus indicating a continuous stroke input. In a further example, the apparatus may determine that at least part of movement input 107 is similar to at least part of movement input 108. In such an example, the apparatus may determine similarity based on angle of movement input 107 prior to release input 104, position of release input 104, angle of movement input 108 after contact input 105, position of contact input 105, and/or the like.

FIG. 1B illustrates a continuous stroke input associated with touch display 121 and touch display 122, according to an example embodiment. In the example of FIG. 1B, the continuous stroke input associated with touch display 121 and touch display 122 comprises contact inputs 123 and 125, movement inputs 127 and 128, and release inputs 124 and 126. Release input 124 relates to an exiting touch display boundary input associated with display 121. Contact input 125 relates to an entering touch display boundary input associated with touch display 122. In the example of FIG. 1B, there is a distance between the bottom touch display boundary of touch display 121 and the top touch display boundary of touch display 122.

In the example of FIG. 1B, an apparatus, such as electronic device 10 of FIG. 6, may determine that inputs 123-128 are comprised by a continuous stroke input based, at least in part, on a relationship between release input 124 and contact input 125. For example, the apparatus may determine that release input 124 was received within a time limit from receiving contact input 125. In such an example, the apparatus may receive release input 124 and contact input 125 within 500 milliseconds of each other. In another example, the apparatus may determine that a position associated with release input 124 is similar to a position associated with contact input 125. In such an example, the similarity may relate to the positions substantially aligning with each other in accordance to the arrangement of touch display 121 and touch display 122. In still another example, the apparatus may determine that contact input 125 was received before release input 124. In such an example, such a determination may indicate that an implement associated with performing input, such as a finger pad, a finger tip, and/or the like, spans the distance between touch display 121 and touch display 122 while performing input, thus indicating a continuous stroke input. In yet another example, there may be a touch sensor between touch displays 121 and 122, and the touch sensor may provide input indicating a continuous stroke input.

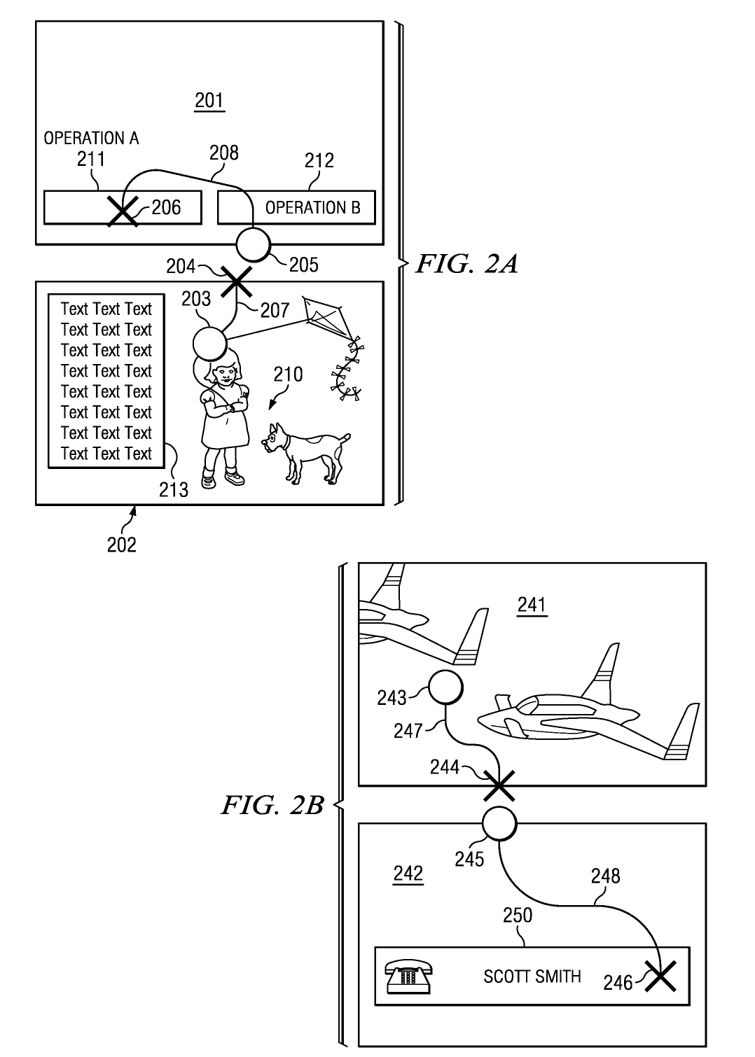

FIGS. 2A-2B are diagrams illustrating continuous stroke input, for example, as described in FIGS. 1A-1B, associated with a plurality of displays, such as display 28 of FIG. 6, according to an example embodiment. The examples of FIGS. 2A-2C are merely examples of possible displays and inputs, and do not limit the scope of the claims. For example, there may be more than two displays and the displays may be comprised in a common apparatus, in multiple apparatuses, such as monitors, and/or the like. In another example, the information associated with one or more of the displays may differ. In yet another example, the continuous stroke input may be part of a multiple touch input, such as touch input 580 of FIG. 5E.

The operation may relate to information associated with the continuous stroke input. The information associated with the continuous stroke input may relate to a program, an icon, text information, an action, a command, an image, a video, and/or the like. The information may be associated with the contact input based, at least in part, on a position of the continuous stroke input in relation to a position relating to display of the information, the information being displayed on the same touch display that received the contact input, a program causing display of the information, and/or the like. For example, a continuous stroke input with a position relating to an image in an image gallery program that is displayed on a touch display, may be associated with the image, the program, the action, the command, a group of images, and/or the like. In such an example, the position relating the continuous stroke input to the information may be associated with a contact input associated with the continuous stroke input, a movement input associated with the continuous stroke input, a release input associated with the continuous stroke input, and/or the like. The apparatus may determine the association based, at least in part, on a relationship between the information and other information, operations that may be performed relating to the information, operations that may be performed relating to the program, predetermined determination criteria, and/or the like.

The continuous stroke input may be associated with at least one information item. An information item may relate to image information, text information, video information, widget information, icon information, a button, an operation indicator, and/or the like. Text information may relate to a character, a group of characters, a word, a group of words, a line of text, a column of text, a block of text, and/or the like. An information item may comprise one or more other information items. For example, an information item may comprise an image information item and text information item. In such an example, the text information item may relate to a caption associated with the image information item. In another example, an information item may comprise two blocks of text information.

The operation may relate to cross functionality between information of the displays, programs associated with the information of the displays, and/or the like. For example, if the continuous stroke input relates to a program associated with a first display, and content associated with a second display, the operation may relate to an operation performed by the program using the content, such as sending the content, modifying the content, rendering the content, and/or the like. Content may relate to text information, image information, audio information, video information, and/or the like. In another example, if the continuous stroke input relates to a program associated with a first program associated with a first display and a second program associated with the second display, the operation may relate to an operation that at least one of the programs may perform in relation to the other. In such an example, the first program may invoke an operation of the second program, the first program may evaluate the second program, the first program may share information with the second program, and/or the like. Cross functionality may relate to an operation shared between the programs, an operation the first program may perform on the second program, an operation that may be performed by both programs, an operation that the first program may perform using information from the second program, and/or the like. In still another example, if the continuous stroke input relates to a first content associated with a first display and a second content associated with a second display, the operation may relate to associating, at least part of, the first content with, at least part of, the second content, inserting the first content into the second content, and/or the like. In such an example, the first content may relate to an image of an individual person, the second content may relate to a group of people, and the operation may relate to associating the first content with part of the second content relating to an individual person in the group of people.

In an example embodiment, an apparatus may cause display of one or more operation indicators. An operation indicator may comprise information to indicate that a user may perform input relating to the operation indicator to invoke an operation. For example, an operation indicator may be a button, a text box, an object, an image, an icon, a shaded region, and/or the like. The operation indicator may indicate information regarding an operation associated with the operation indicator. For example, the operation indicator may describe its associated operation using an image, text, sounds, and/or the like.

The apparatus may cause display of the one or more operation indicators based on various criteria. For example, the apparatus may display the operation indicators whenever there are operations that may be performed associated with information of multiple touch displays. In another example, the apparatus may display the operation indicators in response to input, such as input allowing determination of a continuous stroke input that spans multiple touch displays, for example the continuous stroke inputs of FIGS. 1A-1B. Determination of a continuous stroke input that spans multiple touch displays may be similar as described with reference to FIGS. 1A-1B.

FIG. 2A illustrates a continuous stroke input associated with touch display 201 and touch display 202, according to an example embodiment. In the example of FIG. 2A, the continuous stroke input comprises contact input 203, exiting touch display boundary input 204, movement inputs 207 and 208, entering touch display boundary input 205, and release input 206. Touch display 202 is displaying image 210 and text information item 213. Touch display 201 is displaying operation indicators 211 and 212. Contact input 203 has a position related to image 210 in that contact 203 and image 210 at least partially coincide. Release input 206 has a position related to operation indicator 211 in that release input 206 and operation indicator 211 at least partially coincide.

In an example embodiment, the apparatus may cause display of operation indicators 211 and 212 upon determination that a continuous stroke input may span touch displays 201 and 202. For example, the apparatus may cause display of operation indicators 211 and 212 in response to receiving exiting touch display boundary input 204 and/or entering touch display boundary input 205. In an example embodiment, the apparatus may cause display of operation indicators 211 and 212 regardless of receiving touch input. For example, the application may cause display of operation indicators 211 and 212 prior to receiving any touch input.

In an example embodiment, a program, such as an email program, may be associated with touch display 201, and operation indicators 211 and 212 may relate to operations the program may perform. An apparatus may determine an operation based on an operation associated with operation indicator 211 using information associated with contact input 203. Contact input 203 may be associated with image 210, text information item 213, a program associated with image 210, a program associated with image 210 and text information item 213, and/or the like. For example, the apparatus may determine the operation based on the operation associated with operation indicator 211 using image 210. In another example, the apparatus may determine the operation, based on the operation associated with operation indicator 211, to be between the program associated with touch display 201 and a program associated with image 210, and/or a program associated with touch display 202.

In an example embodiment, the apparatus may associate a program for managing contact information with touch display 201. The apparatus may determine an operation related to sharing image 210 with a person associated with contact information indicated by the program, sending image 210 to a person associated with contact information indicated by the program, associating image 210 with contact information of the program, and/or the like.

In an example embodiment, the apparatus may associate a messaging program, such as an email program, with touch display 201. The apparatus may determine an operation related to sending image 210 in a message, sending a message to an address associated with image 210 and/or text information item 213, and/or the like.

FIG. 2B illustrates a continuous stroke input associated with touch display 241 and touch display 242, according to an example embodiment. In the example of FIG. 2A, the continuous stroke input comprises contact input 243, exiting touch display boundary input 244, movement inputs 247 and 248, entering touch display boundary input 245, and release input 246. Touch display 241 is displaying information. Touch display 241 is displaying information item 250, which relates to a communication program. Release input 246 has a position related to information item 250 in that release input 246 and information item 250 at least partially coincide.

In an example embodiment, the apparatus determines an operation based, at least in part, on position associated with entering touch display boundary input 245 and/or exiting touch display boundary input 244. For example, a region of the top boundary of touch display 242 may be associated with an operation. There may be a plurality of such regions along, at least part of, the top boundary of touch display 242. In another example embodiment, the apparatus determines an operation based, at least in part, on a predetermined cross functionality between the information of touch display 241 and information item 250.

In an example embodiment, a program, such as a game program, may be associated with touch display 241. An apparatus may determine an operation based on cross functionality between the game and the communication program associated with information item 250. For example, the apparatus may initiate game play with a party with whom the communication program is communicating. In another example, the communication program may send an image of the game to a party with whom the communication program is communicating.

In an example embodiment, a video related to the information of touch display 241, for example a video displayed on touch display 241, may be associated with touch display 241. The apparatus may determine an operation based on the video and the communication program. For example the operation may relate to the communication program streaming the video, sending information associated with the video, associating information related to the communication program with the video, and/or the like.

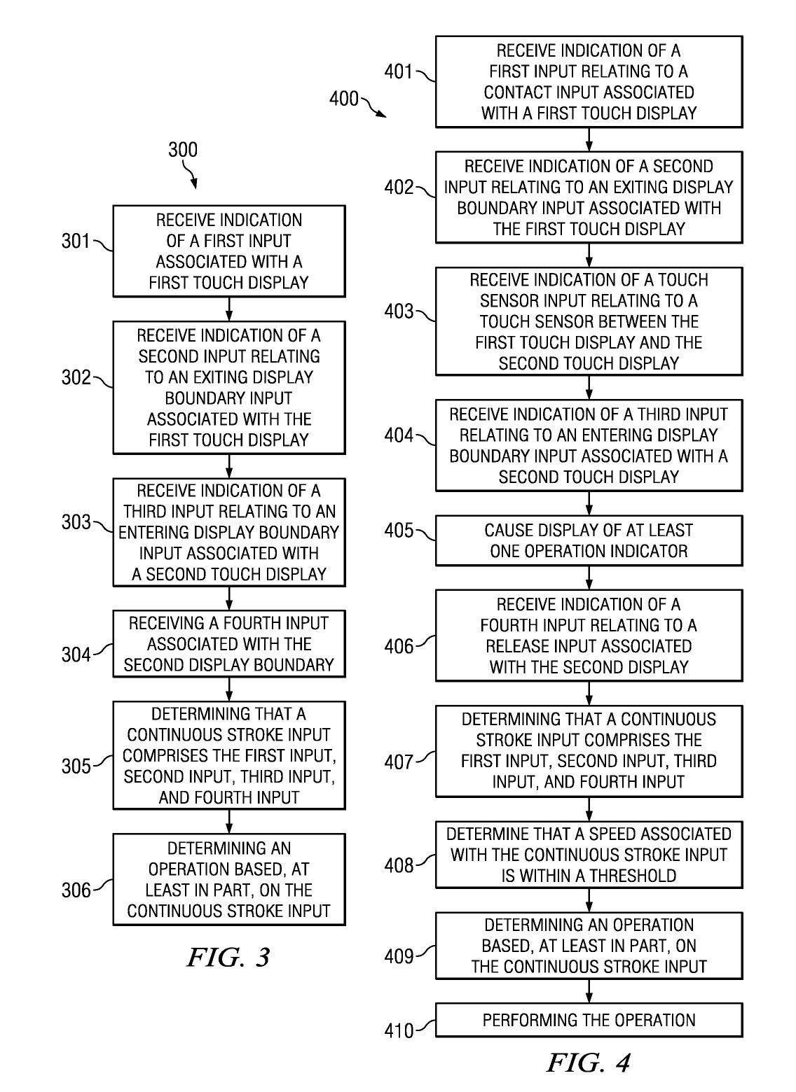

FIG. 3 is a flow diagram showing a set of operations 300 for determining information for display. An apparatus, for example electronic device 10 of FIG. 6 or a portion thereof, may utilize the set of operations 300. The apparatus may comprise means, including, for example processor 20 of FIG. 6, for performing the operations of FIG. 3. In an example embodiment, an apparatus, for example device 10 of FIG. 6, is transformed by having memory, for example memory 42 of FIG. 6, comprising computer code configured to, working with a processor, for example processor 20 of FIG. 6, cause the apparatus to perform set of operations 300.

At block 301, the apparatus receives indication of a first input associated with a first touch display. The apparatus may receive indication of the first input by retrieving information from one or more memories, such as non-volatile memory 42 of FIG. 6, receiving one or more indications of the first input from a part of the apparatus, such as a touch display, for example display 28 of FIG. 6, receiving indication of the first input from a receiver, such as receiver 16 of FIG. 6, receiving first input from a keypad, such as keypad 30 of FIG. 6, and/or the like. In an example embodiment, the apparatus may receive the indication of the first input from a different apparatus, such as a mouse, a keyboard, an external touch display, and/or the like. The first input may relate to a contact input.

At block 302, the apparatus receives indication of a second input relating to an exiting touch display boundary input associated with the first touch display. The receiving may be similar as described with reference to block 301. The exiting touch display boundary input may be similar as described with reference to FIGS. 1A-1B.

At block 303, the apparatus receives indication of a third input relating to an entering touch display boundary input associated with a second touch display. The receiving may be similar as described with reference to block 301. The entering touch display boundary input may be similar as described with reference to FIGS. 1A-1B.

At block 304, the apparatus receives indication of a fourth input associated with the second display. The receiving may be similar as described with reference to block 301. The fourth input may be a release input.

At block 305, the apparatus determines that a continuous stroke input comprises the first input, second input, third input, and fourth input. The determination of the continuous stroke input may be similar as described with reference to FIGS. 1A-1B.

At block 306, the apparatus determines an operation based, at least in part, on the continuous stroke input. The determination of the operation may be similar as described with reference to FIGS. 2A-2B.

FIG. 4 is a flow diagram showing a set of operations 400 for determining information for display. An apparatus, for example electronic device 10 of FIG. 6 or a portion thereof, may utilize the set of operations 400. The apparatus may comprise means, including, for example, processor 20 of FIG. 6, for performing the operations of FIG. 4. In an example embodiment, an apparatus, for example device 10 of FIG. 6, is transformed by having memory, for example memory 42 of FIG. 6, comprising computer code configured to, working with a processor, for example processor 20 of FIG. 6, cause the apparatus to perform set of operations 400.

In an example embodiment, the apparatus comprises a touch sensor, such as sensor 37 of FIG. 6, between the first touch display and the second touch display. The apparatus may receive indication of an input associated with the touch sensor, and determine the continuous stroke input based, at least in part, on the indication of the input associated with the touch sensor.

At block 401, the apparatus receives indication of a first input associated with a first touch display. The receiving may be similar as described with reference to block 301 of FIG. 3.

At block 402, the apparatus receives indication of a second input relating to an exiting touch display boundary input associated with the first touch display. The receiving and exiting touch display input may be similar as described with reference to block 302 of FIG. 3.

At block 403, the apparatus receives indication of an input associated with a touch sensor relating to a touch sensor between the first touch display and the second touch display. The sensor may be similar as described with reference to FIGS. 1A-1B.

At block 404, the apparatus receives indication of a third input relating to an entering touch display boundary input associated with the second touch display. The receiving and entering touch display input may be similar as described with reference to block 303 of FIG. 3.

At block 405, the apparatus causes display of at least one operation indicator. The causing of display of the at least one operation indicator may be similar as described with reference to FIGS. 2A-2B.

At block 406, the apparatus receives indication of a fourth input associated with a second touch display. The receiving may be similar as described with reference to block 304 of FIG. 3.

At block 407, the apparatus determines that a continuous stroke input comprises the first input, the second input, the third input, and fourth input, based, at least in part, on the touch sensor input. For example, the apparatus may determine the continuous stroke input based, at least in part, on a positional relationship between the second input and the touch sensor input, the third input and the touch sensor input, and/or the like. Such determination may be similar as described with reference to the exiting touch display boundary input and entering touch display boundary input of FIGS. 1A-1B. In another example, the apparatus may determine the continuous stroke input based, at least in part, on a temporal relationship between the second input and the touch sensor input, the third input and the touch sensor input, and/or the like. Such determination may be similar as described with reference to the exiting touch display boundary input and entering touch display boundary input of FIGS. 1A-1B.

At block 408, the apparatus determines that a speed associated with the continuous stroke input is within a threshold. For example, the apparatus may perform a predetermined operation, such as a move operation, if the continuous stroke input speed is beyond a threshold, but perform a determined operation if the continuous stroke input speed is within the threshold.

At block 409, the apparatus determines an operation based, at least in part, on the continuous stroke input. The determination may be similar as described with reference to block 306 of FIG. 3.

At block 410, the apparatus performs the operation.

FIGS. 5A-5E are diagrams illustrating input associated with a touch display, for example from display 28 of FIG. 6, according to an example embodiment. In FIGS. 5A-5E, a circle represents an input related to contact with a touch display, two crossed lines represent an input related to releasing a contact from a touch display, and a line represents input related to movement on a touch display. Although the examples of FIGS. 5A-5E indicate continuous contact with a touch display, there may be a part of the input that fails to make direct contact with the touch display. Under such circumstances, the apparatus may, nonetheless, determine that the input is a continuous stroke input. For example, the apparatus may utilize proximity information, for example information relating to nearness of an input implement to the touch display, to determine part of a touch input.

In the example of FIG. 5A, input 500 relates to receiving contact input 502 and receiving a release input 504. In this example, contact input 502 and release input 504 occur at the same position. In an example embodiment, an apparatus utilizes the time between receiving contact input 502 and release input 504. For example, the apparatus may interpret input 500 as a tap for a short time between contact input 502 and release input 504, as a press for a longer time between contact input 502 and release input 504, and/or the like. In such an example, a tap input may induce one operation, such as selecting an item, and a press input may induce another operation, such as performing an operation on an item. In another example, a tap and/or press may relate to a user selected text position.

In the example of FIG. 5B, input 520 relates to receiving contact input 522, a movement input 524, and a release input 526. Input 520 relates to a continuous stroke input. In this example, contact input 522 and release input 526 occur at different positions. Input 520 may relate to dragging an object from one position to another, to moving a scroll bar, to panning a virtual screen, to drawing a shape, and/or the like. In an example embodiment, an apparatus interprets input 520 based at least in part on the speed of movement 524. For example, if input 520 relates to panning a virtual screen, the panning motion may be small for a slow movement, large for a fast movement, and/or the like. In another example embodiment, an apparatus interprets input 520 based at least in part on the distance between contact input 522 and release input 526. For example, if input 520 relates to a scaling operation, such as resizing a box, the scaling may relate to the distance between contact input 522 and release input 526. An apparatus may interpret the input before receiving release input 526. For example, the apparatus may evaluate a change in the input, such as speed, position, and/or the like. In such an example, the apparatus may perform one or more determinations based upon the change in the touch input. In such an example, the apparatus may modify a text selection point based at least in part on the change in the touch input.

In the example of FIG. 5C, input 540 relates to receiving contact input 542, a movement input 544, and a release input 546 as shown. Input 540 relates to a continuous stroke input. In this example, contact input 542 and release input 546 occur at different positions. Input 540 may relate to dragging an object from one position to another, to moving a scroll bar, to panning a virtual screen, to drawing a shape, and/or the like. In an example embodiment, an apparatus interprets input 540 based at least in part on the speed of movement 544. For example, if input 540 relates to panning a virtual screen, the panning motion may be small for a slow movement, large for a fast movement, and/or the like. In another example embodiment, an apparatus interprets input 540 based at least in part on the distance between contact input 542 and release input 546. For example, if input 540 relates to a scaling operation, such as resizing a box, the scaling may relate to the distance between contact input 542 and release input 546. In still another example embodiment, the apparatus interprets the position of the release input. In such an example, the apparatus may modify a text selection point based at least in part on the change in the touch input.

In the example of FIG. 5D, input 560 relates to receiving contact input 562, and a movement input 564, where contact is released during movement. Input 560 relates to a continuous stroke input. Input 560 may relate to dragging an object from one position to another, to moving a scroll bar, to panning a virtual screen, to drawing a shape, and/or the like. In an example embodiment, an apparatus interprets input 560 based at least in part on the speed of movement 564. For example, if input 560 relates to panning a virtual screen, the panning motion may be small for a slow movement, large for a fast movement, and/or the like. In another example embodiment, an apparatus interprets input 560 based at least in part on the distance associated with the movement input 564. For example, if input 560 relates to a scaling operation, such as resizing a box, the scaling may relate to the distance of the movement input 564 from the contact input 562 to the release of contact during movement.

In an example embodiment, an apparatus may receive multiple touch inputs at coinciding times. For example, there may be a tap input at a position and a different tap input at a different location during the same time. In another example there may be a tap input at a position and a drag input at a different position. An apparatus may interpret the multiple touch inputs separately, together, and/or a combination thereof. For example, an apparatus may interpret the multiple touch inputs in relation to each other, such as the distance between them, the speed of movement with respect to each other, and/or the like.

In the example of FIG. 5E, input 580 relates to receiving contact inputs 582 and 588, movement inputs 584 and 590, and release inputs 586 and 592. Input 520 relates to two continuous stroke inputs. In this example, contact input 582 and 588, and release input 586 and 592 occur at different positions. Input 580 may be characterized as a multiple touch input. Input 580 may relate to dragging an object from one position to another, to moving a scroll bar, to panning a virtual screen, to drawing a shape, to indicating one or more user selected text positions and/or the like. In an example embodiment, an apparatus interprets input 580 based at least in part on the speed of movements 584 and 590. For example, if input 580 relates to zooming a virtual screen, the zooming motion may be small for a slow movement, large for a fast movement, and/or the like. In another example embodiment, an apparatus interprets input 580 based at least in part on the distance between contact inputs 582 and 588 and release inputs 586 and 592. For example, if input 580 relates to a scaling operation, such as resizing a box, the scaling may relate to the collective distance between contact inputs 582 and 588 and release inputs 586 and 592.

In an example embodiment, the timing associated with the apparatus receiving contact inputs 582 and 588, movement inputs 584 and 590, and release inputs 586 and 592 varies. For example, the apparatus may receive contact input 582 before contact input 588, after contact input 588, concurrent to contact input 588, and/or the like. The apparatus may or may not utilize the related timing associated with the receiving of the inputs. For example, the apparatus may utilize an input received first by associating the input with a preferential status, such as a primary selection point, a starting position, and/or the like. In another example, the apparatus may utilize non-concurrent inputs as if the apparatus received the inputs concurrently. In such an example, the apparatus may utilize a release input received first the same way that the apparatus would utilize the same input if the apparatus had received the input second.

Even though an aspect related to two touch inputs may differ, such as the direction of movement, the speed of movement, the position of contact input, the position of release input, and/or the like, the touch inputs may be similar. For example, a first touch input comprising a contact input, a movement input, and a release input, may be similar to a second touch input comprising a contact input, a movement input, and a release input, even though they may differ in the position of the contact input, and the position of the release input.

FIG. 6 is a block diagram showing an apparatus, such as an electronic device 10, according to an example embodiment. It should be understood, however, that an electronic device as illustrated and hereinafter described is merely illustrative of an electronic device that could benefit from embodiments of the invention and, therefore, should not be taken to limit the scope of the invention. While one embodiment of the electronic device 10 is illustrated and will be hereinafter described for purposes of example, other types of electronic devices, such as, but not limited to, portable digital assistants (PDAs), pagers, mobile computers, desktop computers, televisions, gaming devices, laptop computers, media players, cameras, video recorders, global positioning system (GPS) devices and other types of electronic systems, may readily employ embodiments of the invention. Moreover, the apparatus of an example embodiment need not be the entire electronic device, but may be a component or group of components of the electronic device in other example embodiments.

Furthermore, devices may readily employ embodiments of the invention regardless of their intent to provide mobility. In this regard, even though embodiments of the invention are described in conjunction with mobile communications applications, it should be understood that embodiments of the invention may be utilized in conjunction with a variety of other applications, both in the mobile communications industries and outside of the mobile communications industries.

The electronic device 10 may comprise an antenna, (or multiple antennae), a wired connector, and/or the like in operable communication with a transmitter 14 and a receiver 16. The electronic device 10 may further comprise a processor 20 or other processing circuitry that provides signals to and receives signals from the transmitter 14 and receiver 16, respectively. The signals may comprise signaling information in accordance with a communications interface standard, user speech, received data, user generated data, and/or the like. The electronic device 10 may operate with one or more air interface standards, communication protocols, modulation types, and access types. By way of illustration, the electronic device 10 may operate in accordance with any of a number of first, second, third and/or fourth-generation communication protocols or the like. For example, the electronic device 10 may operate in accordance with wireline protocols, such as Ethernet, digital subscriber line (DSL), asynchronous transfer mode (ATM), second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), or with fourth-generation (4G) wireless communication protocols, wireless networking protocols, such as 802.11, short-range wireless protocols, such as Bluetooth, and/or the like.

As used in this application, the term ‘circuitry’ refers to all of the following: hardware-only implementations (such as implementations in only analog and/or digital circuitry) and to combinations of circuits and software and/or firmware such as to a combination of processor(s) or portions of processor(s)/software including digital signal processor(s), software, and memory(ies) that work together to cause an apparatus, such as a mobile phone or server, to perform various functions and to circuits, such as a microprocessor(s) or portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor, multiple processors, or portion of a processor and its (or their) accompanying software and/or firmware. The term “circuitry” would also cover, for example, a baseband integrated circuit or applications processor integrated circuit for a mobile phone or a similar integrated circuit in a cellular network device or other network device.

Processor 20 may comprise means, such as circuitry, for implementing audio, video, communication, navigation, logic functions, and/or the like, as well as for implementing embodiments of the invention including, for example, one or more of the functions described in conjunction with FIGS. 1-5. For example, processor 20 may comprise means, such as a digital signal processor device, a microprocessor device, various analog to digital converters, digital to analog converters, processing circuitry and other support circuits, for performing various functions including, for example, one or more of the functions described in conjunction with FIGS. 1-5. The apparatus may perform control and signal processing functions of the electronic device 10 among these devices according to their respective capabilities. The processor 20 thus may comprise the functionality to encode and interleave message and data prior to modulation and transmission. The processor 20 may additionally comprise an internal voice coder, and may comprise an internal data modem. Further, the processor 20 may comprise functionality to operate one or more software programs, which may be stored in memory and which may, among other things, cause the processor 20 to implement at least one embodiment including, for example, one or more of the functions described in conjunction with FIGS. 1-6. For example, the processor 20 may operate a connectivity program, such as a conventional internet browser. The connectivity program may allow the electronic device 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic device 10 may comprise a user interface for providing output and/or receiving input. The electronic device 10 may comprise an output device such as a ringer, a conventional earphone and/or speaker 24, a microphone 26, a display 28, and/or a user input interface, which are coupled to the processor 20. The user input interface, which allows the electronic device 10 to receive data, may comprise means, such as one or more devices that may allow the electronic device 10 to receive data, such as a keypad 30, a touch display, for example if display 28 comprises touch capability, and/or the like. In an embodiment comprising a touch display, the touch display may be configured to receive input from a single point of contact, multiple points of contact, and/or the like. In such an embodiment, the touch display and/or the processor may determine input based on position, motion, speed, contact area, and/or the like.

The electronic device 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. Display 28 may be display two-dimensional information, three-dimensional information and/or the like.

In embodiments including the keypad 30, the keypad 30 may comprise numeric (for example, 0-9) keys, symbol keys (for example, #, *), alphabetic keys, and/or the like for operating the electronic device 10. For example, the keypad 30 may comprise a conventional QWERTY keypad arrangement. The keypad 30 may also comprise various soft keys with associated functions. In addition, or alternatively, the electronic device 10 may comprise an interface device such as a joystick or other user input interface. The electronic device 10 further comprises a battery 34, such as a vibrating battery pack, for powering various circuits that are required to operate the electronic device 10, as well as optionally providing mechanical vibration as a detectable output.

In an example embodiment, the electronic device 10 comprises a media capturing element, such as a camera, video and/or audio module, in communication with the processor 20. The media capturing element may be any means for capturing an image, video and/or audio for storage, display or transmission. For example, in an example embodiment in which the media capturing element is a camera module 36, the camera module 36 may comprise a digital camera which may form a digital image file from a captured image. As such, the camera module 36 may comprise hardware, such as a lens or other optical component(s), and/or software necessary for creating a digital image file from a captured image. Alternatively, the camera module 36 may comprise only the hardware for viewing an image, while a memory device of the electronic device 10 stores instructions for execution by the processor 20 in the form of software for creating a digital image file from a captured image. In an example embodiment, the camera module 36 may further comprise a processing element such as a co-processor that assists the processor 20 in processing image data and an encoder and/or decoder for compressing and/or decompressing image data. The encoder and/or decoder may encode and/or decode according to a standard format, for example, a Joint Photographic Experts Group (JPEG) standard format.

The electronic device 10 may comprise one or more user identity modules (UIM) 38. The UIM may comprise information stored in memory of electronic device 10, a part of electronic device 10, a device coupled with electronic device 10, and/or the like. The UIM 38 may comprise a memory device having a built-in processor. The UIM 38 may comprise, for example, a subscriber identity module (SIM), a universal integrated circuit card (UICC), a universal subscriber identity module (USIM), a removable user identity module (R-UIM), and/or the like. The UIM 38 may store information elements related to a subscriber, an operator, a user account, and/or the like. For example, UIM 38 may store subscriber information, message information, contact information, security information, program information, and/or the like. Usage of one or more UIM 38 may be enabled and/or disabled. For example, electronic device 10 may enable usage of a first UIM and disable usage of a second UIM.

In an example embodiment, electronic device 10 comprises a single UIM 38. In such an embodiment, at least part of subscriber information may be stored on the UIM 38.

In another example embodiment, electronic device 10 comprises a plurality of UIM 38. For example, electronic device 10 may comprise two UIM 38 blocks. In such an example, electronic device 10 may utilize part of subscriber information of a first UIM 38 under some circumstances and part of subscriber information of a second UIM 38 under other circumstances. For example, electronic device 10 may enable usage of the first UIM 38 and disable usage of the second UIM 38. In another example, electronic device 10 may disable usage of the first UIM 38 and enable usage of the second UIM 38. In still another example, electronic device 10 may utilize subscriber information from the first UIM 38 and the second UIM 38.

Electronic device 10 may comprise a memory device including, in one embodiment, volatile memory 40, such as volatile Random Access Memory (RAM) including a cache area for the temporary storage of data. The electronic device 10 may also comprise other memory, for example, non-volatile memory 42, which may be embedded and/or may be removable. The non-volatile memory 42 may comprise an EEPROM, flash memory or the like. The memories may store any of a number of pieces of information, and data. The information and data may be used by the electronic device 10 to implement one or more functions of the electronic device 10, such as the functions described in conjunction with FIGS. 1-6. For example, the memories may comprise an identifier, such as an international mobile equipment identification (IMEI) code, which may uniquely identify the electronic device 10.

Electronic device 10 may comprise one or more sensor 37. Sensor 37 may comprise a light sensor, a proximity sensor, a motion sensor, a location sensor, and/or the like. For example, sensor 37 may comprise one or more light sensors at various locations on the device. In such an example, sensor 37 may provide sensor information indicating an amount of light perceived by one or more light sensors. Such light sensors may comprise a photovoltaic element, a photoresistive element, a charge coupled device (CCD), and/or the like. In another example, sensor 37 may comprise one or more proximity sensors at various locations on the device. In such an example, sensor 37 may provide sensor information indicating proximity of an object, a user, a part of a user, and/or the like, to the one or more proximity sensors. Such proximity sensors may comprise capacitive measurement, sonar measurement, radar measurement, and/or the like.

Although FIG. 6 illustrates an example of an electronic device that may utilize embodiments of the invention including those described and depicted, for example, in FIGS. 1-6, electronic device 10 of FIG. 6 is merely an example of a device that may utilize embodiments of the invention.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media. In the context of this document, a “computer-readable medium” may be any tangible media or means that can contain, or store the instructions for use by or in connection with an instruction execution system, apparatus, or device, such as a computer, with one example of a computer described and depicted in FIG. 6. A computer-readable medium may comprise a computer-readable storage medium that may be any tangible media or means that can contain or store the instructions for use by or in connection with an instruction execution system, apparatus, or device, such as a computer.

If desired, the different functions discussed herein may be performed in a different order and/or concurrently with each other. For example, block 302 of FIG. 3 may be performed after block 303. In another example, block 409 of FIG. 4 may be performed prior to block 408. Furthermore, if desired, one or more of the above-described functions may be optional or may be combined. For example, block 408 of FIG. 4 may be optional or combined with block 409.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

What is claimed is:

1. An apparatus, comprising:
a processor;
memory including computer program code, the memory and the computer program code configured to, working with the processor, cause the apparatus to perform at least the following:
receiving indication of a first input associated with a first touch display;
receiving indication of a second input relating to an exiting touch display boundary input associated with the first touch display;
receiving indication of a third input relating to an entering touch display boundary input associated with a second touch display;
receiving indication of a fourth input associated with the second display;
determining that a continuous stroke input comprises the first input, second input, third input, and fourth input; and
determining an operation based, at least in part, on the continuous stroke input.

2. The apparatus of claim 1, wherein the first input relates to a contact input and the operation is based, at least in part, on the first input.

3. The apparatus of claim 2, wherein the first input is associated with a first information item caused to be displayed on the first touch display, and the operation is based, at least in part, on the information item.

4. The apparatus of claim 1, wherein the fourth input relates to a release input and the operation is based, at least in part, on the fourth input.

5. The apparatus of claim 4, wherein the fourth input relates to a second information item caused to be displayed on the second touch display, and the operation is based, at least in part, on the second information item.

6. The apparatus of claim 1, wherein the operation is based at least in part on a position associated with the third input.

7. The apparatus of claim 1, wherein the memory and computer program code are further configured to, working with the processor, cause the apparatus to perform at least causing display of at least one operation indicator.

8. The apparatus of claim 7, wherein the causing of display of the at least one operation indicator is performed in response to the second input.

9. The apparatus of claim 7, wherein the causing of display of the at least one operation indicator is performed in response to the third input.

10. The apparatus of claim 7, wherein the first input relates to a first program, the fourth input relates to a second program, and the at least one operation indicator relates to at least one operation relating to cross functionality between the first program and the second program.

11. The apparatus of claim 1, wherein the first input relates to an information item associated with content, the fourth input relates to a program, and the operation relates to an operation that the program performs using, at least part of, the content.

12. The apparatus of claim 1, wherein the first input relates to a first content, the fourth input relates to a second content, and the operation relates to forming an association between, at least part of, the first content and, at least part of, the second content.

13. The apparatus of claim 1, wherein the determination of the continuous stroke input is based, at least in part, on receiving the third input and receiving the second input within a time limit.

14. The apparatus of claim 1, wherein the determination of the continuous stroke input is based, at least in part, on a position associated with the second input and a position associated with the third input.

15. The apparatus of claim 1, wherein the determination of the continuous stroke input is based, at least in part, on the apparatus receiving the third input before receiving the second input.

16. The apparatus of claim 1, wherein the apparatus further comprises a touch sensor between the first touch display and the second touch display, the memory and computer program code are further configured to, working with the processor, cause the apparatus to perform at least receiving indication of an input associated with the touch sensor, and the determination of the continuous stroke input is based, at least in part, on the indication of the input associated with the touch sensor.

17. The apparatus of claim 1, wherein the memory and computer program code are further configured to, working with the processor, cause the apparatus to perform at least determining that a speed associated with the continuous stroke input is within a threshold.

18. The apparatus of claim 1, wherein the apparatus comprises the first display and the second display.

19. A method, comprising:
receiving indication of a first input associated with a first touch display;
receiving indication of a second input relating to an exiting touch display boundary input associated with the first touch display;
receiving indication of a third input relating to an entering touch display boundary input associated with a second touch display;
receiving indication of a fourth input associated with the second display;
determining by a processor that a continuous stroke input comprises the first input, second input, third input, and fourth input; and
determining an operation based, at least in part, on the continuous stroke input.

20. A computer-readable medium encoded with instructions that, when executed by a computer, perform:
receiving indication of a first input associated with a first touch display;
receiving indication of a second input relating to an exiting touch display boundary input associated with the first touch display;
receiving indication of a third input relating to an entering touch display boundary input associated with a second touch display;
receiving indication of a fourth input associated with the second display;
determining that a continuous stroke input comprises the first input, second input, third input, and fourth input; and
determining an operation based, at least in part, on the continuous stroke input.
